(19) United States
(12) Patent Application Publication
(10) Pub. No.: US 2026/0113671 A1
(43) Pub. Date: Apr. 23, 2026

(54) SYSTEM AND METHODS OF PERFORMING HANDOVER TESTS

(71) Applicant: T-Mobile USA, Inc., Bellevue, WA (US)

(72) Inventors: Noshad Bagha, Shoreline, WA (US); Uday Yagnesh Dave, Sammamish, WA (US); Adeel Ahmed, Bellevue, WA (US)

(21) Appl. No.: 18/924,814

(22) Filed: Oct. 23, 2024

(51) Int. Cl. H04W 36/00; H04L 41/50; H04L 41/5067

(52) U.S. Cl. CPC H04W 36/0058; H04L 41/5067; H04L 41/5087

(57) ABSTRACT

The disclosed system is a testing system configured to perform a handover test. The testing system includes a first test chamber having a turntable positioned to hold a wireless device connected to a cellular network. A second test chamber comprises a Wi-Fi signal source configured to supply the Wi-Fi signal to the wireless device and a control system. The control system varies a signal strength of the Wi-Fi signal at a predetermined interval while the wireless device is rotated by the turntable. The control system obtains measurement results that indicate a variation of the signal strength of the Wi-Fi signal due to a change of a position of the wireless device. The control system identifies an occurrence of a handover from the cellular signal to the Wi-Fi signal in response to the variation.

### BACKGROUND

Wi-Fi calling, also called VoWiFi, refers to mobile phone voice calls and data that are made over IP networks using Wi-Fi instead of the cell towers provided by cellular networks. Using this feature, compatible handsets are able to route regular cellular calls through a wireless local area network (Wi-Fi) network with broadband internet while seamlessly changing connections between the two where necessary.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3A illustrates a schematic view of an example testing system in accordance with one or more embodiments of the present technology.

FIG. 3B illustrates an embodiment of a test chamber of the testing system.

FIG. 3C illustrates an embodiment of the testing system.

FIG. 4A illustrates example results from a multiple handover test.

FIG. 4B illustrates example results from a multiple handover test.

FIG. 4C illustrates example results from a multiple handover test.

FIG. 5A illustrates example results from a single handover test.

FIG. 5B illustrates example results from a single handover test.

FIG. 6 illustrates a flow diagram of an embodiment of the system.

FIG. 7 is a block diagram that illustrates components of a computing device.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to a testing system for testing handovers between Wi-Fi and cellular data on a wireless device. Handovers commonly occur when a wireless device performs Voice over Internet Protocol (VoIP) phone calls. VoIP is a technology that enables users to make voice calls and other communications over the Internet instead of using a traditional phone line. A wireless device can perform VoIP phone calls using Wi-Fi or cellular signals on a telecommunications network. Both Wi-Fi and cellular signals have varying signal strengths depending on the location of the wireless device, which affects the quality of the VoIP call. Additionally, Wi-Fi signals typically have a smaller range than cellular signals, limiting the geographic area where the wireless device can perform a VoIP call while connected to a Wi-Fi signal. Switching between a Wi-Fi signal and a cellular signal during a call handover can lead to dropped calls or reduced call quality when the call handover occurs either too early or too late. Therefore, call handover is often not enabled on wireless devices because the wireless device does not know when to perform the call handover.

The disclosed system uses multiple test or test chambers and a turntable to test for the optimal handover time based on the current signal strength of the Wi-Fi signal and cellular signal. The wireless device is placed on the turntable and then rotated. Rotating the wireless device increases the repeatability of the call handover test. When the handover test is a call handover test, the system transmits a Wi-Fi and cellular signal and causes the wireless device to perform a VoIP call while the wireless device rotates on the turntable. The system varies the signal strength of the Wi-Fi and/or cellular signal to simulate the wireless device moving to different locations and to cause the wireless device to attempt to perform a call handover. The system averages the signal strengths at each point in the rotation as measured on the wireless device. Averaging the signal strength reduces errors and outliers caused by signal fluctuations common with Wi-Fi signals, enabling more accurate measurements. The system uses the average signal strengths to determine when or if the call handover occurs. The data gathered during the testing procedure can be used to optimize call handovers so that calls are not dropped and ensure that call quality is not lowered during less-than-optimal VoIP calling conditions.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

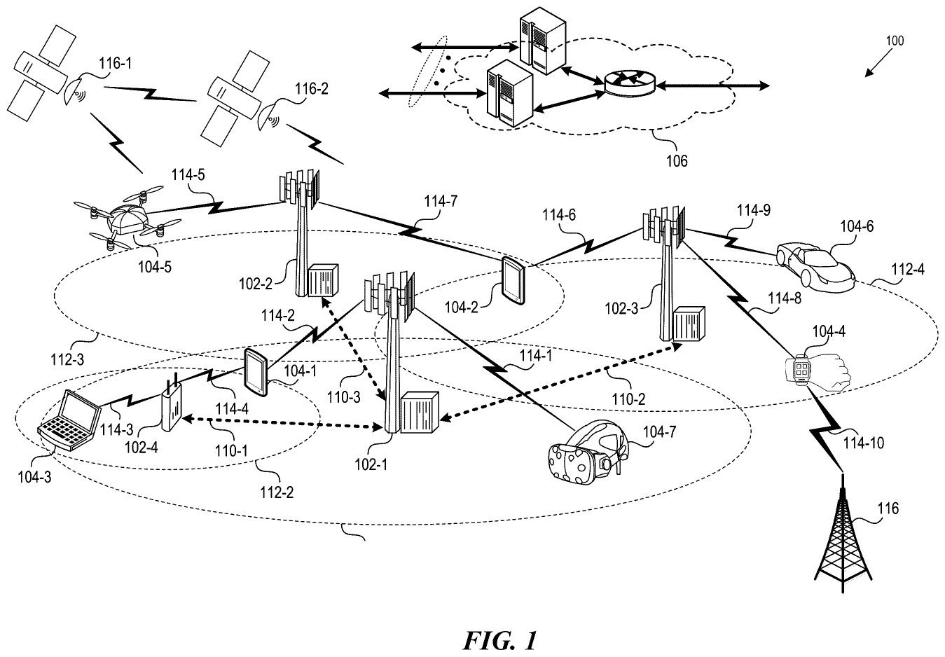

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

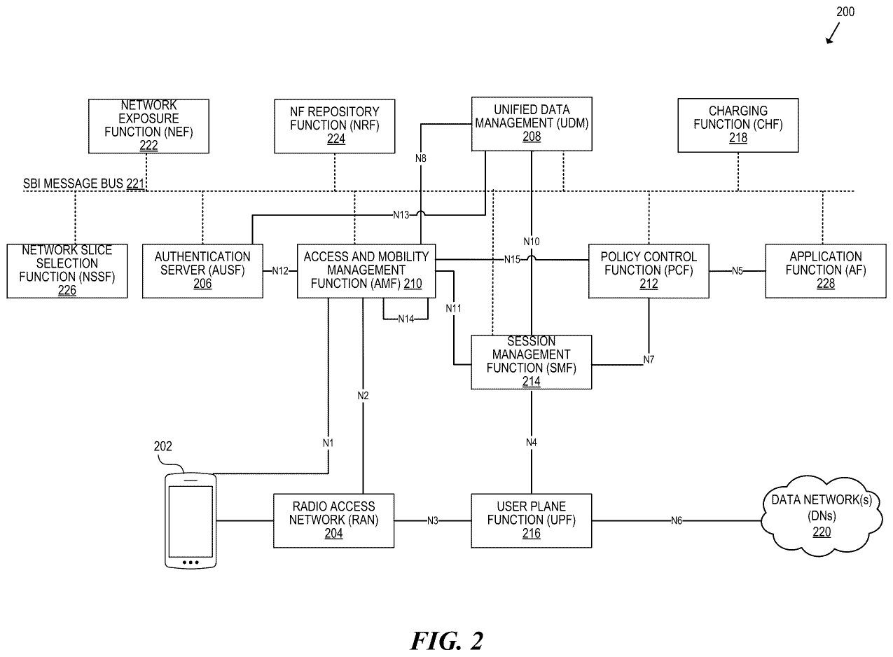

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Testing Solution for Wi-Fi Calling

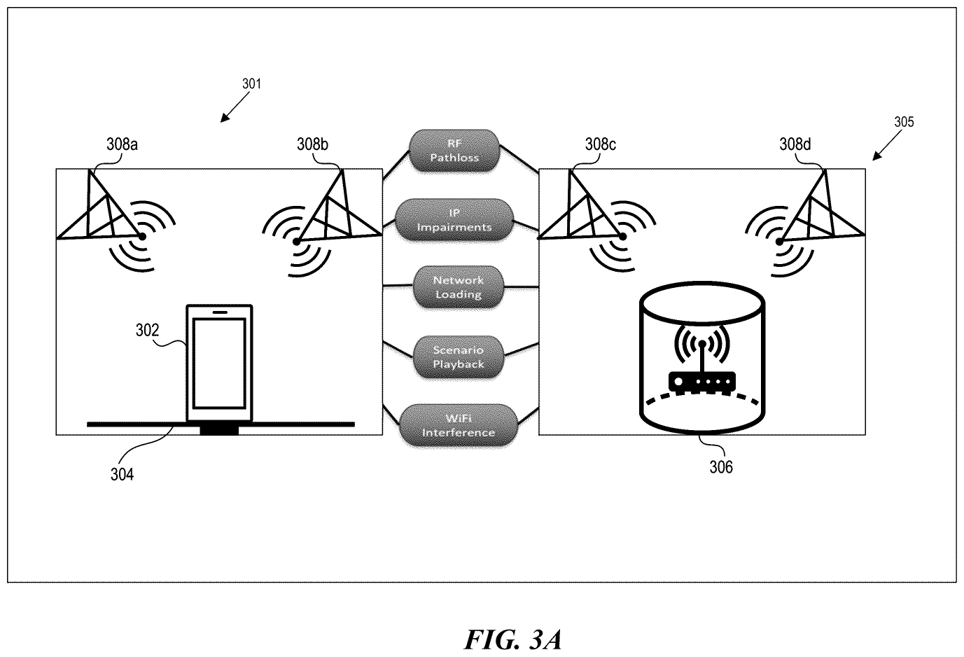

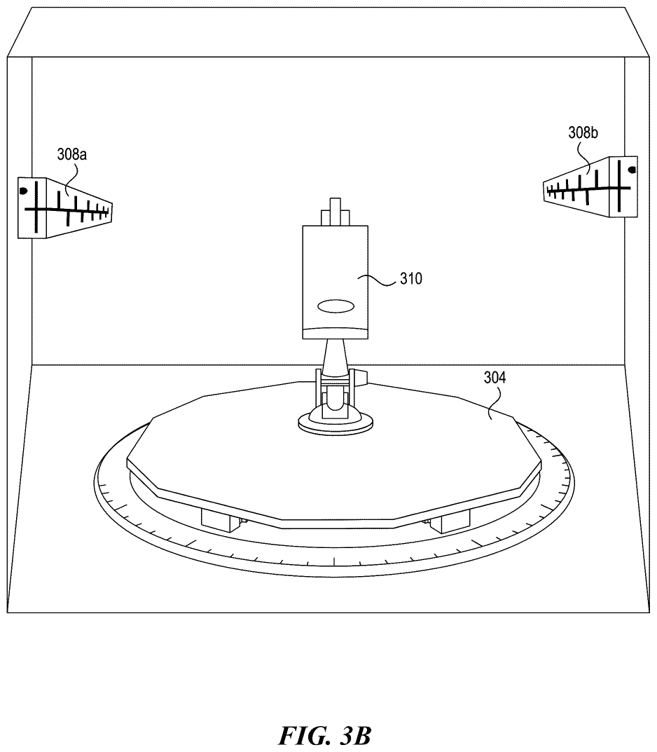

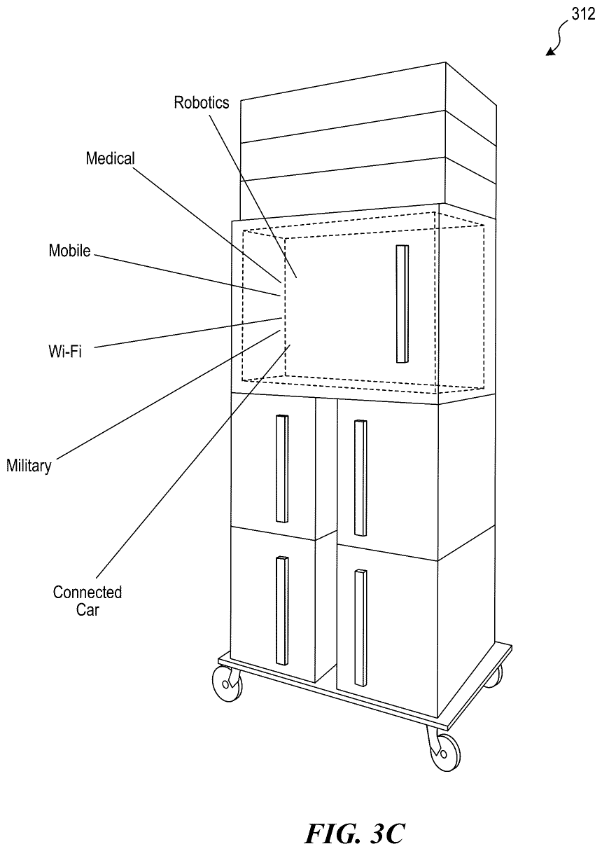

FIG. 3A illustrates a schematic view of an example testing system in accordance with one or more embodiments of the present technology. This example testing system is configured to perform a VoIP call handover test. The testing system includes a first test chamber 301 and a second test chamber 305. The first test chamber 301 can include a wireless device 302, a turntable 304, and measurement antennas 308a, 308b. The wireless device 302 can be any device capable of performing a VoIP call, such as a smartphone or tablet. The wireless device 302 is placed on the turntable 304. The turntable 304 rotates the wireless device 302 during a handover test. The turntable 304 is configured to rotate or spin on a fixed axis. The axis can be a center or offset axis to change the path on which the turntable rotates. The turntable 304 can be constructed from a low dielectric material that does not interfere with the variety of wireless signals measured with the testing system. The turntable 304 increases the repeatability of the handover test by enabling the wireless device 302 to receive a wireless signal (e.g., Wi-Fi signal or cellular signal) from different angles. The signal strength can be averaged at different angles to determine an average signal strength. Averaging the signal strength eliminates inconsistencies in the testing setup caused by unsymmetric antenna distribution, signal diffraction, and/or antenna placement inside the wireless device. The measurement antennas 308a, 308b can be positioned inside the first test chamber 301 to perform specific measurements, such as Wi-Fi signal strength, cellular signal strength, and/or any interferences. The measurement antennas 308a, 308b can be positioned throughout the first test chamber 301, such as at the top, sides, or bottom of the first test chamber 301. In some embodiments, the first test chamber includes one, two, four, or six measurement antennas 308a, 308b.

The second test chamber 305 can include a Wi-Fi transmitter 306 and measurement antennas 308c, 308d. The Wi-Fi transmitter 306 is configured to provide a Wi-Fi signal to the wireless device 302 located in the first test chamber 301. The wireless device 302 connects to the Wi-Fi signal during a handover test. The measurement antennas 308c, 308d can be positioned inside the second test chamber 305 to perform specific measurements, such as the Wi-Fi signal strength emitted from the Wi-Fi transmitter 306 and/or any interferences. The measurement antennas 308c, 308d can be positioned throughout the second test chamber 305, such as at the top, sides, or bottom of the second test chamber 305. In some embodiments, the second test chamber includes one, two, four, or six measurement antennas 308c, 308d.

During a handover test, the testing system can measure radio frequency (RF) path loss. RF path loss is the decrease in power density of an RF signal as it travels through space. Path loss can occur due to free-space loss, refraction, diffraction, reflection, aperture-medium coupling loss, and/or absorption. The testing system can measure the RF path loss of both the Wi-Fi signal and cellular signal to determine the strength of each signal. When the handover test is a call handover test, measuring the RF path loss can help determine the call quality of a VoIP call. The testing system can also test IP impairments. IP impairments enable the simulation of real-world conditions during a handover test. For example, an IP impairment can be network latency, network delay variation, bandwidth, congestion, packet loss, and/or packet errors. Modifying the different IP impairments can yield results that are more aligned with real-world conditions, leading to better determinations of when a handover should occur. Similar to IP impairments, the testing system can also adjust network loading settings to emulate real-world traffic and loads experienced by a network. During a handover test, the testing system can also cause Wi-Fi interference to disrupt the Wi-Fi connection, lowering the Wi-Fi signal speeds. This can simulate the Wi-Fi signal transmitted through walls or ceilings or interfered with by electronic devices like microwave ovens.

FIG. 3B illustrates an embodiment of a test chamber of the testing system. The test chamber includes the turntable 304, multiple measurement antennas 308, and a device mount 310. The turntable 304 can include degree markings that indicate what location in the rotation the turntable is at. The device mount 310 supports the wireless device being tested in a fixed position. For example, the device mount 310 can be configured to support a wireless device such as a smartphone. The device mount 310 can position the wireless device away from the turntable to reduce any interference caused by the turntable 304.

FIG. 3C illustrates an embodiment of the testing system. Each chamber of the testing system is located inside the movable testing cart 312. The testing cart 312 is a movable system that enables the handover test to be performed from multiple locations, such as inside or outside of a building or near a telecommunications node. For example, the testing cart 312 can be placed on wheels to increase mobility and enable quick positional adjustments of the testing cart 312. The testing cart 312 can be configured to test a variety of wireless devices. A wireless device can be any device capable of connecting to a cellular network and a Wi-Fi network or any device capable of performing calls over a cellular network and Wi-Fi network. For example, the testing cart 312 can test medical devices, drones, mobile devices, smartphones, small robotics, IoT devices, etc. In some embodiments, the testing cart 312 can be configured to test aspects of a connected car by positioning the testing cart 312 near the car during a handover test.

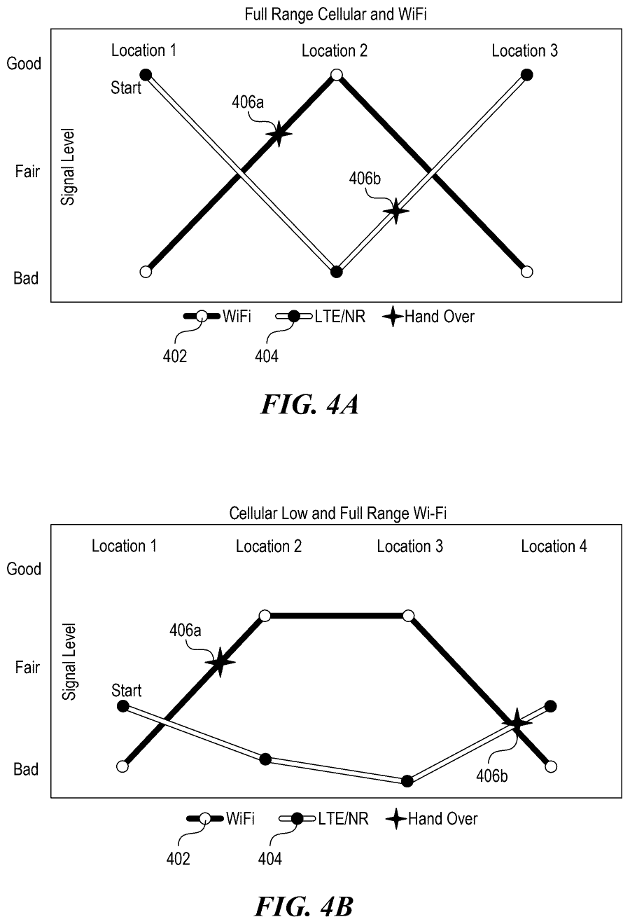

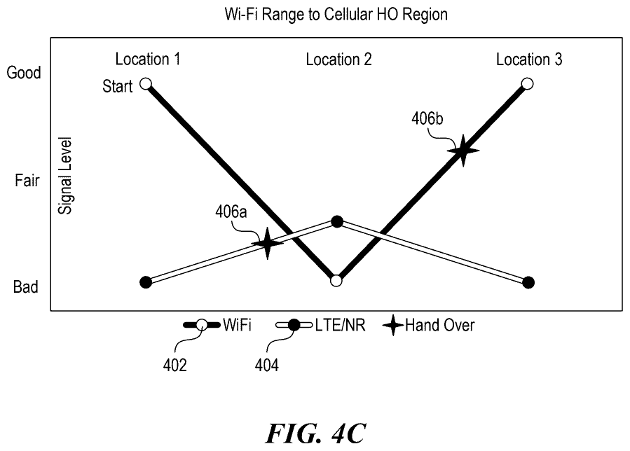

The system simulates changing the location of the wireless device by varying the signal strength of the Wi-Fi signal 402 and the cellular signal 404 while rotating the wireless device on a turntable. The different signal strengths tested can be based on different profiles that represent real-world scenarios, such as performing a VoIP call while entering and leaving one's home. During a call handover test, as illustrated in FIGS. 4A-4C, the wireless device performs a VoIP call and switches between the Wi-Fi signal 402 and the cellular signal 404 for performing the VoIP call based on the respective signal strength of the Wi-Fi signal 402 and the cellular signal 404. The signal strength is categorized as good, fair, or bad. For example, good signal strength can mean the wireless device can perform a VoIP call with no issues and without dropping the call. A bad signal strength can mean the wireless device may encounter problems or drop the call when trying to maintain or perform a VoIP call. The wireless device can either begin or end on the call handover test connected to the Wi-Fi signal 402 or the cellular signal 404. Usage of the example testing system shown in FIGS. 3A-3C allows consistent playback of the same testing profile(s) across different device types in a controlled wireless environment to help evaluate performance differences among the devices.

FIGS. 4A-4C illustrate example measurements using the disclosed testing techniques in accordance with one or more embodiments of the present technology. FIG. 4A illustrates example results from a multiple handover test. The embodiment of the multiple handover test uses a testing profile that covers the full range of Wi-Fi and cellular signal strength from good to bad. For example, the testing profile can simulate a user entering and leaving their home or office while performing a VoIP call. At location 1, the wireless device is connected to the cellular signal 404 and actively performs a VoIP call. Location 1 has a good cellular signal strength and a bad Wi-Fi signal strength. Location 1 can correspond to when the wireless device first enters the range of a Wi-Fi network. The signal strengths are adjusted to simulate the wireless device moving from location 1 to location 2. As the wireless device moves toward location 2, the cellular signal strength decreases from good to bad, and the Wi-Fi signal strength increases from bad to good. Location 2 can correspond to the wireless device being near a Wi-Fi router inside a building where walls, ceilings, etc., block the cellular signal. Due to the change in signal strength of the cellular signal 404 and the Wi-Fi signal 402, a first call handover 406a occurs where the wireless device disconnects from the cellular signal 404 and connects to the Wi-Fi signal to continue performing the VoIP call. The signal strengths are adjusted to simulate the wireless device moving from location 2 to location 3. As the wireless device moves toward location 3, the cellular signal 404 increases from bad to good signal strength, and the Wi-Fi signal 402 decreases from good to bad signal strength. Location 3 can correspond to a similar situation as location 1, where the wireless device is located at the edge of the Wi-Fi network. Due to the change in signal strength of the cellular signal 404 and the Wi-Fi signal 402, a second call handover 406b occurs where the wireless device disconnects from the Wi-Fi signal 402 and connects to the cellular signal 404 to continue performing the VoIP call.

FIG. 4B illustrates example results from a multiple handover test. The alternate embodiment of the multiple handover test uses a profile that covers the full range of Wi-Fi signal strength and a low range of cellular signal strengths. At location 1, the wireless device is connected to the cellular signal 404 and is actively performing a VoIP call. Location 1 has a fair cellular signal strength and a bad Wi-Fi signal strength. Location 1 can represent the wireless device being located inside of a building at the edge of the Wi-Fi network and either at a location away from a network node of the telecommunications network or at a location where the cellular signal 404 is partially interfered with by a wall or electronic device. The signal strengths are adjusted to simulate the wireless device moving from location 1 to location 2. As the wireless device moves toward location 2, the signal strength of the cellular signal 404 decreases from fair to bad, and the signal strength of the Wi-Fi signal 402 increases from bad to good. Location 2 can represent the wireless device being located near a Wi-Fi router at a location where there is interference to the cellular network such as a wall between the wireless device and network node of the cellular network or the wireless device being located toward the edge of the telecommunications network. Due to the change in signal strength of the cellular signal 404 and the Wi-Fi signal 402, a first call handover 406a occurs where the wireless device disconnects from the cellular signal 404 and connects to the Wi-Fi signal 402 in order to continue performing the VoIP call. The signal strengths are adjusted to simulate the wireless device moving from location 2 to location 3. As the wireless device moves toward location 3, the signal strength of the cellular signal 404 decreases further, while the signal strength of the Wi-Fi signal 402 remains constant. Location 3 can represent the wireless device being located near a second wireless router in the wireless network, as is common in large office buildings or homes. Additionally, location 3 can represent a location having additional interference to the cellular signal 404 when compared to location 2. Because the Wi-Fi signal strength remained stronger than the cellular signal strength, no call handover occurred. The signal strengths are adjusted to simulate the wireless device moving from location 3 to location 4. As the wireless device moves toward location 4, the signal strength of the cellular signal 404 increases from bad to fair, while the signal strength of the Wi-Fi signal 402 decreases from good to bad. Location 4 can represent the wireless device being located at a location similar to that of location 1, where the wireless device is located at the edge of the Wi-Fi network where there is some interference to the cellular signal 404. Due to the change in signal strength of the cellular signal 404 and the Wi-Fi signal 402, a second call handover 406b occurs where the wireless device disconnects from the Wi-Fi signal 402 and connects to the cellular signal 404 to continue performing the VoIP call.

FIG. 4C illustrates example results from a multiple handover test. The alternate embodiment of the multiple handover test uses a testing profile that covers the full range of Wi-Fi signal strength and a low range of cellular signal strengths. At location 1, the wireless device is connected to the Wi-Fi signal 402 and actively performs a VoIP call. Location 1 has a good Wi-Fi signal strength and a bad cellular signal strength. Location 1 can represent the wireless device being located near a Wi-Fi router but in a cellular signal 404 dead zone. A dead zone is a location where there is either no wireless signal or a very weak wireless signal. The signal strengths are adjusted to simulate the wireless device moving from location 1 to location 2. As the wireless device moves toward location 2, the signal strength of the cellular signal 404 increases from bad to fair, while the signal strength of the Wi-Fi signal 402 decreases from good to bad. Location 2 can represent the wireless device being located in a Wi-Fi signal dead zone that has a cellular signal 404 with some interferences. Due to the change in signal strength of the cellular signal 404 and the Wi-Fi signal 402, a first call handover 406a occurs where the wireless device disconnects from the Wi-Fi signal 402 and connects to the cellular signal 404 to continue performing the VoIP call. The signal strengths are adjusted to simulate the wireless device moving from location 2 to location 3. As the wireless device moves toward location 3, the signal strength of the cellular signal 404 decreases from fair to bad, while the signal strength of the Wi-Fi signal 402 increases from bad to good. Location 3 can represent the wireless device entering a location similar to location 1, where the wireless device is in a cellular signal 404 dead zone with a strong Wi-Fi signal 402. Due to the change in signal strength of the cellular signal 404 and the Wi-Fi signal 402, a second call handover 406b occurs where the wireless device disconnects from the cellular signal 404 and connects to the Wi-Fi signal 402 to continue performing the VoIP call.

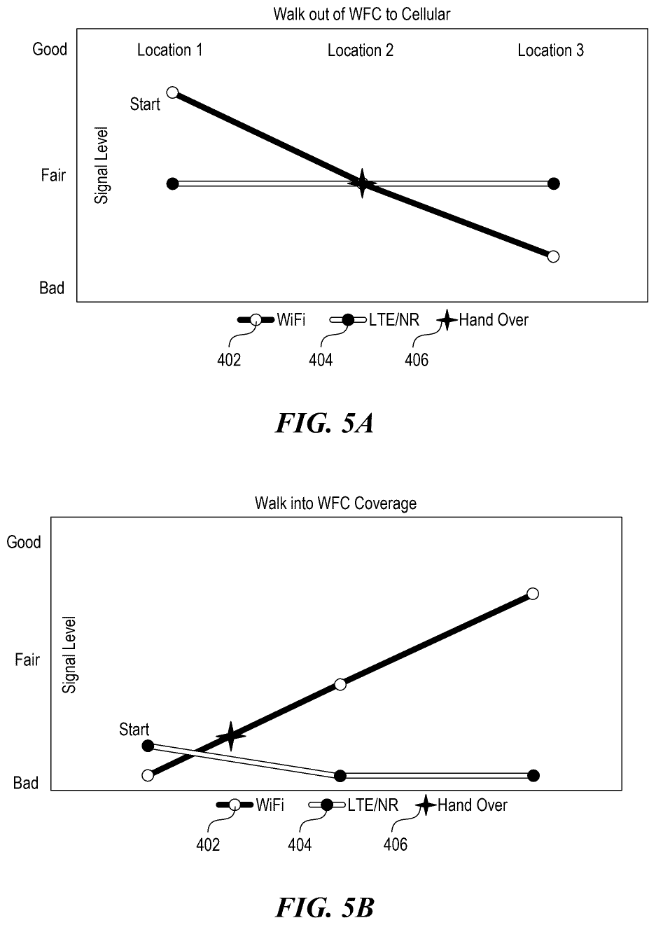

FIGS. 5A-5B illustrate possible signal strengths for a Wi-Fi signal 402 and cellular signal 404 for a call handover test when a wireless device enters or leaves a Wi-Fi network such as that in a user's home. The system simulates changing the location of the wireless device by varying the signal strength of Wi-Fi signal 402 and cellular signal 404 while rotating the wireless device on a turntable. The profiles illustrated in FIGS. 5A-5B represent entering and leaving a Wi-Fi network and vice versa. The profiles as used in FIGS. 5A-5B show a call handover test, where the wireless device performs a VoIP call and switches between the Wi-Fi signal 402 and the cellular signal 404 for performing the VoIP call based on whether the wireless device is entering or leaving the Wi-Fi network range. During the call handover test, the wireless device performs a VoIP call and switches between the Wi-Fi signal 402 and the cellular signal 404 for performing the VoIP call based on the respective signal strength of the Wi-Fi signal 402 and the cellular signal 404. The signal strength is categorized as good, fair, or bad. For example, good signal strength can mean the wireless device can perform a VoIP call with no issues and without dropping the call. A bad signal strength can mean the wireless device may encounter problems or drop the call when trying to maintain or perform a VoIP call.

FIG. 5A illustrates an embodiment of the results from a single handover test where the wireless device leaves the range of the Wi-Fi network range. At location 1, the wireless device is connected to the Wi-Fi signal 402 and actively performs a VoIP call. Location 1 can represent a user beginning the VoIP call while connected to and in range of a Wi-Fi network and telecommunications network. Location 1 has a good Wi-Fi signal strength and a fair cellular signal strength. Location 1 can represent typical conditions in most homes, where there is a strong Wi-Fi signal 402 and an average cellular signal 404. The signal strengths are adjusted to simulate the wireless device moving from location 1 to location 3. At location 3, the signal strength of the Wi-Fi signal 402 changes from good to bad, while the signal strength of the cellular signal 404 remains constant at fair. A call handover 406 occurs at location 2 while the wireless device moves to location 3. When the call handover 406 occurs, the wireless device disconnects from the Wi-Fi signal 402 and connects to the cellular signal 404 to continue performing the VoIP call. Location 2 is the point where the signal strength of the Wi-Fi signal 402 and the cellular signal 404 are equal.

FIG. 5B illustrates an alternate embodiment of the results from a single handover test where the wireless device enters the range of the Wi-Fi network range. At location 1, the wireless device is connected to the cellular signal 404 and actively performs a VoIP call. Location 1 represents a user beginning the VoIP call while entering the range of the Wi-Fi network. At location 1, the signal strength of the cellular signal 404 is stronger than the signal strength of the Wi-Fi signal 402. Location 1 can represent conditions when a wireless device is at the edge of a home Wi-Fi network, where the home is located far away from the network node of the telecommunications network. The signal strengths are adjusted to simulate the wireless device moving from location 1 to location 3. At location 3, the signal strength of the Wi-Fi signal 402 changes from bad to good, while the signal strength of the cellular signal 404 decreases further to be worse than the strength of the Wi-Fi signal. Location 3 can represent the wireless device entering a home or building, causing there to be an increase in the strength of the Wi-Fi signal 402 and a decrease in the strength of the cellular signal 404 due to the cellular signal 404 experiencing interference from the wall of the building. A call handover 406 occurs between location 1 and location 2. When the call handover 406 occurs, the wireless device disconnects from the cellular signal 404 and connects to the Wi-Fi signal 402 to continue performing the VoIP call. The call handover 406 occurs between locations 1 and 2 due to the increased signal strength of the Wi-Fi signal 402 and the bad signal strength of the cellular signal 404. After the call handover 406 occurs, the wireless device continues moving to location 3, where the signal strength of the cellular signal remains bad. In contrast, the signal strength of the Wi-Fi network continues to increase until it is good.

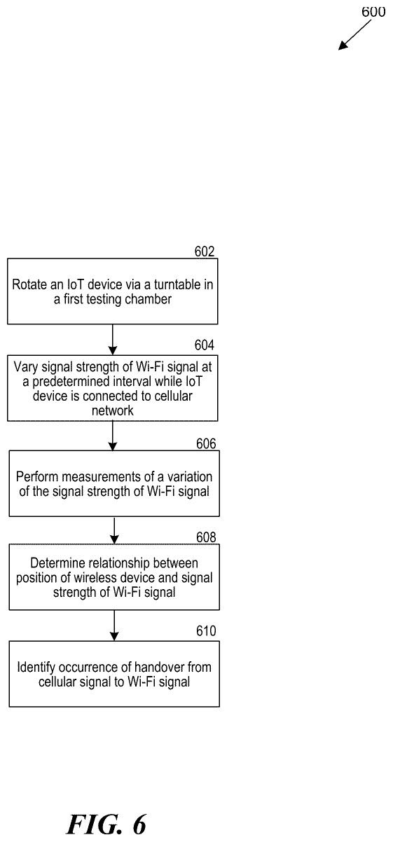

FIG. 6 illustrates a flow diagram of an embodiment of the system. In one example, the system includes at least one hardware processor and at least one non-transitory memory storing instructions, which, when executed by the at least one hardware processor, cause the wireless device to perform the process 600.

At step 602, the system rotates a wireless device via a turntable in a first test chamber. At step 604, the system varies a signal strength of a Wi-Fi signal at a predetermined interval while the wireless device is connected to a cellular network. The Wi-Fi signal is generated from a Wi-Fi signal source located in a second test chamber. In some embodiments, the system moves the first chamber and the second chamber to a new location. The system adjusts, based on the movement of the first chamber and the second chamber, a signal strength of the cellular signal.

At step 606, the system performs measurements of a variation of the signal strength of the Wi-Fi signal. In some embodiments, the measurements include a latency of the Wi-Fi signal, a throughput of the Wi-Fi signal, or an RF path loss of the Wi-Fi signal. The system can cause an internet protocol (IP) impairment on the Wi-Fi signal, where the IP impairment modifies the latency or bandwidth of the Wi-Fi signal. The system can cause Wi-Fi interference to the Wi-Fi signal, where the Wi-Fi interference lowers the throughput of the Wi-Fi signal. The system can adjust a network loading setting to increase a load on the Wi-Fi signal.

At step 608, the system determines, in addition to the variation of the signal strength, a relationship between a position of the wireless device and the signal strength of the Wi-Fi signal. At step 610, the system identifies an occurrence of a handover from the cellular signal to the Wi-Fi signal due to a change of the position of the wireless device.

In some embodiments, the wireless device is a wireless device and the handover test is a call handover test. The system can measure VoIP call quality and calculate a mean opinion score (MOS) at predetermined intervals during the VoIP call based on the measured VoIP call quality. The MOS is used to measure the overall perceived quality of the VoIP call. For example, the MOS can take into account metrics like jitter and latency, which have an effect on the VoIP call quality. The system can also measure for an occurrence of a call drop, where the call drop occurs when the VoIP call stops before the call handover test is complete.

### Computer System

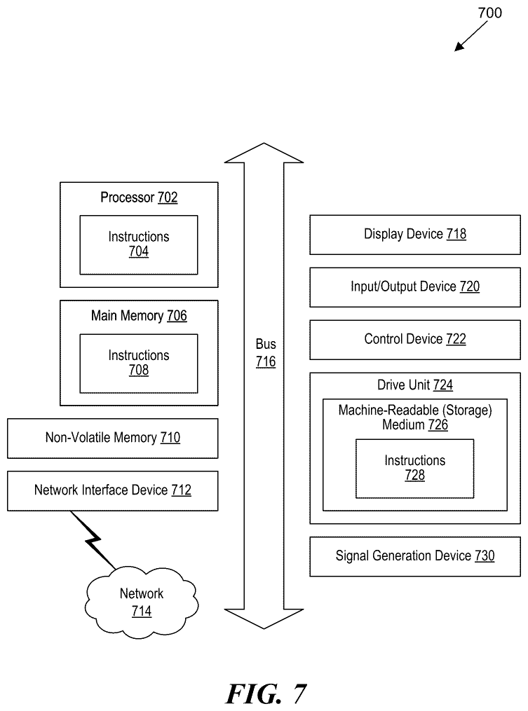

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to. ” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A testing system configured to perform a call handover test comprising:
a first test chamber including:
a turntable positioned to hold a wireless device connected to a cellular network,
wherein the wireless device is configured to perform a Voice over Internet Protocol (VoIP) call using either a cellular signal from the cellular network or a Wi-Fi signal,
wherein the turntable is configured to rotate the wireless device within the first test chamber during the VoIP call;
a second test chamber comprising a Wi-Fi signal source configured to supply the Wi-Fi signal to the wireless device; and
a control system including at least one hardware processor and at least one non-transitory memory storing instructions, which, when executed by the at least one hardware processor, cause the testing system to:
vary a signal strength of the Wi-Fi signal at a predetermined interval while the wireless device is rotated by the turntable;
obtain measurement results that indicate a variation of the signal strength of the Wi-Fi signal due to a change of a position of the wireless device; and
identify an occurrence of a handover for the VoIP call from the cellular signal to the Wi-Fi signal in response to the variation.

2. The testing system of claim 1, wherein the control system further causes the testing system to:
measure VoIP call quality; and
calculate a mean opinion score (MOS) at predetermined intervals during the VoIP call based on the measured VoIP call quality.

3. The testing system of claim 1, wherein the control system further causes the testing system to:
measure for an occurrence of a call drop,
wherein the call drop occurs when the VoIP call stops before the call handover test is complete.

4. The testing system of claim 1, wherein the control system measures:
a latency of the Wi-Fi signal,
a throughput of the Wi-Fi signal, or
a radio frequency path loss of the Wi-Fi signal.

5. The testing system of claim 4, wherein the control system further causes the testing system to:
cause an internet protocol (IP) impairment on the Wi-Fi signal,
wherein the IP impairment modifies the latency or bandwidth of the Wi-Fi signal.

6. The testing system of claim 4, wherein the control system further causes the testing system to:
cause Wi-Fi interference to the Wi-Fi signal,
wherein the Wi-Fi interference lowers the throughput of the Wi-Fi signal.

7. The testing system of claim 1, wherein the control system further causes the testing system to:
adjust a network loading setting to increase a load on the Wi-Fi signal.

8. The testing system of claim 1, further comprising:
a testing cart configured to house the first test chamber, the second test chamber, and the control system,
wherein the testing cart includes wheels enabling movement of the testing cart to different locations.

9. A method of performing a handover test comprising:
rotating a wireless device via a turntable in a first test chamber;
varying a signal strength of a Wi-Fi signal at a predetermined interval while the wireless device is connected to a cellular network,
wherein the Wi-Fi signal is generated from a Wi-Fi signal source located in a second test chamber;
performing measurements of a variation of the signal strength of the Wi-Fi signal;
determining, in addition to the variation of the signal strength, a relationship between a position of the wireless device and the signal strength of the Wi-Fi signal; and
identifying an occurrence of a handover from a cellular signal to the Wi-Fi signal due to a change of the position of the wireless device.

10. The method of claim 9, wherein the measurements include:
a latency of the Wi-Fi signal,
a throughput of the Wi-Fi signal, or
a radio frequency path loss of the Wi-Fi signal.

11. The method of claim 10, further comprising:
causing an internet protocol (IP) impairment on the Wi-Fi signal,
wherein the IP impairment modifies the latency or bandwidth of the Wi-Fi signal.

12. The method of claim 10, further comprising:
causing Wi-Fi interference to the Wi-Fi signal,
wherein the Wi-Fi interference lowers the throughput of the Wi-Fi signal.

13. The method of claim 10, further comprising:
adjusting a network loading setting to increase a load on the Wi-Fi signal.

14. The method of claim 9, further comprising:
moving the first test chamber and the second test chamber to a new location; and
adjusting, based on a movement of the first test chamber and the second test chamber, a signal strength of the cellular signal.

15. A non-transitory, computer-readable storage medium comprising instructions recorded thereon, wherein the instructions, when executed by at least one data processor of a system, cause the system to:
rotate a wireless device via a turntable in a first test chamber;
vary a signal strength of a Wi-Fi signal at a predetermined interval while the wireless device is connected to a cellular network,
wherein the Wi-Fi signal is generated from a Wi-Fi signal source located in a second test chamber;
perform measurements of a variation of the signal strength of the Wi-Fi signal;
determine, in addition to the variation of the signal strength, a relationship between a position of the wireless device and the signal strength of the Wi-Fi signal; and
identify an occurrence of a handover from a cellular signal to the Wi-Fi signal due to a change of the position of the wireless device.

16. The non-transitory, computer-readable storage medium of claim 15, wherein the measurements include:
a latency of the Wi-Fi signal,
a throughput of the Wi-Fi signal, or
a radio frequency path loss of the Wi-Fi signal.

17. The non-transitory, computer-readable storage medium of claim 16, wherein the instructions further cause the system to:
cause an internet protocol (IP) impairment on the Wi-Fi signal,
wherein the IP impairment modifies the latency or bandwidth of the Wi-Fi signal.

18. The non-transitory, computer-readable storage medium of claim 16, wherein the instructions further cause the system to:
cause Wi-Fi interference to the Wi-Fi signal,
wherein the Wi-Fi interference lowers the throughput of the Wi-Fi signal.

19. The non-transitory, computer-readable storage medium of claim 16, wherein the instructions further cause the system to:
adjust a network loading setting to increase a load on the Wi-Fi signal.

20. The non-transitory, computer-readable storage medium of claim 15, wherein the instructions further cause the system to:
move the first test chamber and the second test chamber to a new location; and
adjust, based on a movement of the first test chamber and the test second chamber, a signal strength of the cellular signal.
